(19) United States
(12) Patent Application Publication
(10) Pub. No.: US 2012/0055875 A1
(43) Pub. Date: Mar. 8, 2012

(54) METHOD TO TREAT PRODUCED WATERS FROM THERMALLY INDUCED HEAVY CRUDE OIL PRODUCTION (TAR SANDS)

(75) Inventor: Larry Lien, Solana Beach, CA (US)

(73) Assignee: GENERAL ELECTRIC COMPANY, Schenectady, NY (US)

(21) Appl. No.: 12/874,735

(22) Filed: Sep. 2, 2010

(51) Int. Cl. C02F 1/44; C02F 1/58; C02F 1/66; C02F 1/42

(52) U.S. Cl. 210/638; 210/641; 210/639

(57) ABSTRACT

A method for treating oil field produced wastewater containing high organics, silica, boron, hardness, and suspended and dissolved solids by applying three membrane types in series is provided. First, Ultrafiltration (UF) is applied to remove oil and suspended solids. Second, Nanofiltration (NF) is used to reject hardness, soluble iron and organics. Subsequently, the NF permeate is treated by a double pass Reverse Osmosis (RO) process. The first-pass is applied at a high temperature of about 180° F. and low pH to remove the majority of the salts and silica. Then the feed is chilled, stripped of carbon dioxide and finally pH adjusted to 10 to maximize boron removal.

### BACKGROUND OF THE INVENTION

1. Field of the Invention

This invention relates generally to a method for treating oil field produced wastewater containing high organics, silica, boron, hardness, and suspended and dissolved solids, and more particularly to a method for treating the wastewater to a level sufficient to meet requirements to discharge the treated water.

2. Description of Related Art

One method used to improve recovery of viscous or heavy crude oil involves injecting steam into an oil deposit resulting in the recovery of an oil/water mixture. The water is then removed from this oil/water mixture. The disposal of this oil field produced wastewater is problematic due to the presence of relatively high concentrations of organics, silica, boron, hardness, suspended and dissolved solids. With increasing water quality standards, surface discharge of the produced water has become even more problematic and has produced a need for methods to treat the produced water prior to discharge. In addition, the loss of drinking and/or irrigation water in arid regions presents a motivation to reclaim the produced water to a purity level allowing above ground disposal. Unfortunately, the contaminants present in produced water vary depending upon its origin and the particular characteristics of the oil well site. This has made the standardization of water treatment facilities difficult. If such wastewater or produced water is to be injected underground at a remote site, treated for surface discharge, or reused in high purity applications, such as feed to a boiler or steam generator, then there must be a substantial reduction in the silica, total hardness, dissolved solids and organics contained therein.

Reverse osmosis processes have been used for desalting produced water or wastewater. However, the recovery across reverse osmosis systems is often limited by scaling due to silica or fouling due to organics. That is, high concentrations of silica in the feed water tend to scale the reverse osmosis membranes due to the concentration of silica exceeding solubility limits. Organics that exceed solubility limits also tend to foul the reverse osmosis membranes. Scaling due to silica and fouling due to organics can cause substantial down time of the reverse osmosis unit or units, requiring frequent cleaning, replacement and maintenance. In addition, processes are designed to remove silica and boron. These contaminants are often present in the form of weakly ionized salts, sicilic acid and boric acid, and generally, reverse osmosis membranes are not efficient in rejecting such weakly ionized salts.

In light of these difficulties, there is a need for an economical process for treating produced water that reduces fouling due to organics, reduces scaling due to silica, and which will efficiently reduce the concentrations of silica, organics, dissolved solids and hardness in the produced water to levels that are acceptable for surface discharge under various state and/or federal regulations.

### SUMMARY OF THE INVENTION

In one aspect, the invention is directed to a method of treating a produced water stream from oil recovery operations having a temperature between 160° F. (71° C.) and 200° F. (93° C.) and containing high concentrations of soluble and insoluble organic and inorganic contaminants. The process includes passing the produced water stream to a pretreatment phase to obtain a filtered produced water stream, wherein the produced water stream is subjected to a pH adjustment, wherein the pH of the pH adjusted produced water stream is less than 6.0. The filtered produced water stream is then passed to an ultrafiltration (UF) phase to recover an ultrafiltration permeate having reduced oil and suspended solids. The ultrafiltration permeate is passed to a nanofiltration (NF) phase to recover a nanofiltration permeate having reduced soluble organics, hardness and iron. The nanofiltration permeate having a pH between 4.5 and 6.0 is passed to a two-pass reverse osmosis (RO) phase to recover a reverse osmosis permeate. The RO phase includes a first-pass RO membrane that rejects salts and silica and a second-pass RO membrane that rejects boron. The first-pass RO permeate is subjected to an air stripper system that removes CO₂ and cools the first-pass RO permeate to less than 95° F. (35° C.). The first-pass RO permeate is also subjected to a pH adjustment, wherein the pH is raised to at least 10 for improved boron removal.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a flow chart of a method of water treatment according to an exemplary embodiment of the invention.

Corresponding reference characters indicate corresponding parts throughout the views of the drawings.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The singular forms “a,” “an” and “the” include plural referents unless the context clearly dictates otherwise.

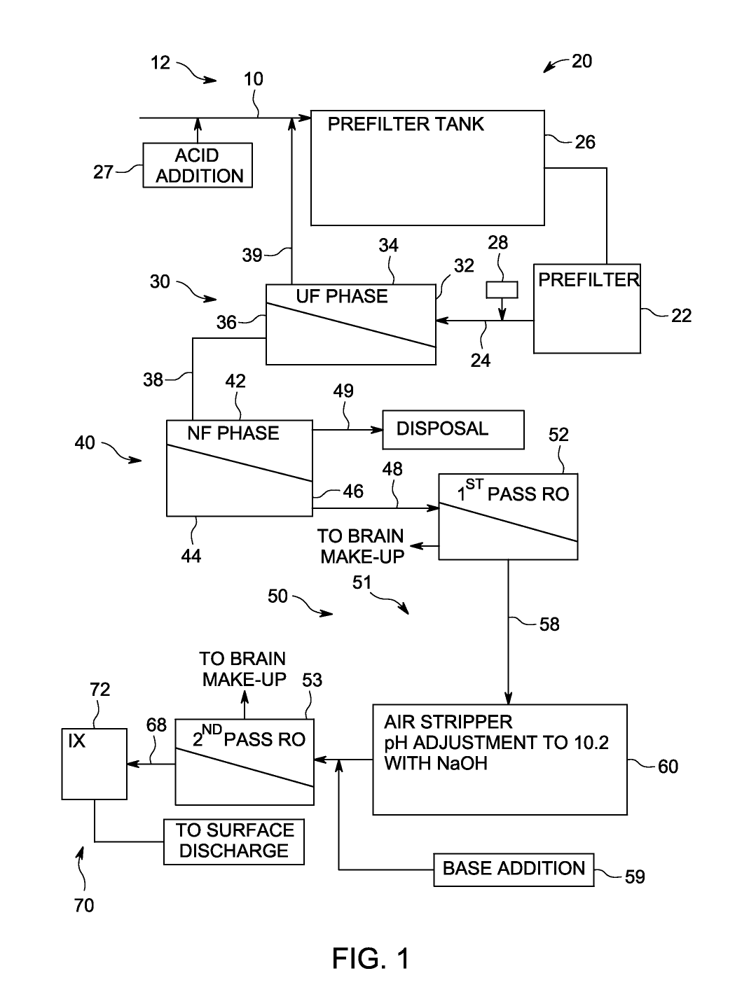

Referring to FIG. 1, a produced water stream 10 from oil recovery operations containing high concentrations of contaminants is subject to oil separation and passage through a produced water treatment system 12 using a multiple membrane technology approach to yield water that meets state and federal quality standards. In one exemplary embodiment, the feed source is produced water generated from steam injection used to induce oil production from heavy crude deposits. As such, the produced water stream 10 is of high temperature, such as between about 160° F. (71° C.) and 200° F. (93° C.). Besides being very hot, the produced water stream 10 contains high levels of salts (about 10,000 ppm), oil (<10 PPM), suspended solids, iron at saturation, silica at saturation (about 200 ppm) and boron (100-150 ppm). According to the invention, the produced water stream 10 is subjected to a process employing a pretreatment phase 20, an ultrafiltration (UF) phase 30, a nanofiltration (NF) phase 40 and a reverse osmosis (RO) phase 50 as will be set forth below.

### Pretreatment

As one skilled in the art will readily appreciate, large contaminants and/or oil droplets, if any, may be removed from the produced water stream 10 in the prefiltration phase 20 prior to subjecting the produced water to the additional process described herein employing, for example, a prefilter 22. The use of prefilters 22 is well known in the art. In general, the produced water stream 10 will pass through prefilter 22 to remove any of the contaminants and/or droplets present therein to provide a filtered produced water stream 24. Any type of cartridge, screen or back-washable bag may be used such as, for example, a 25, 50, 75 or 100-micron prefilter cartridge. Additionally, the prefiltration phase 22 may include passing the produced water stream 10 through a media filter (not shown) comprising anthracite, walnut shells, garnet or similar media and combinations thereof. In the prefiltration phase 20, a prefiltration tank 26 may be used to collect the produced water stream 10 to permit CO₂ off gassing. Additionally, a continuous overflow from the top of the tank 26 removes floatable solids (oil) and a clean out at the bottom of the tank 26 permits removal of settled solids.

In the prefilter stage 20, the pH of the produced water stream 10 is adjusted to a pH of less than about 6.0 for maintaining iron in solution prior to the UF phase 30. In one embodiment, pH is adjusted with sulfuric acid to a pH of 5.8. Keeping iron in solution prior to the UF phase 30 is desirable for successful processing. In one embodiment, 93% sulfuric acid (H₂SO₄) is added from an acid addition tank 27 to the oil and solids laden produced water stream 10 prior to the process tank 26 and a controller 28 placed after the prefilter 22 to keep the probe clean to aid in obtaining reliable readings.

### Ultrafiltration Phase

Following the filtering of the large contaminants and/or oil droplets, if any, from the product water stream 10, the filtered produced water stream 24 is passed into contact with a high pressure side 32 of ultrafiltration membrane 34 in the UF phase 30 to remove insoluble contaminants present therein. An ultrafiltration permeate 38 is recovered from a low pressure side 36 of the ultrafiltration membrane 34, and an ultrafiltration retentate 39 is recovered from the high pressure side 32 of the membrane 34. Suitable ultrafiltration membranes 34 used in the UF phase 30 are known in the art. Desirably, the ultrafiltration membrane 34 is a hydrophilic membrane, i.e., a membrane having an affinity for water so it rejects oil to give a substantially oil and suspended solids free feed to the subsequent downstream membrane processes. A useful material for forming the membrane 34 is a polyacrylonitrile. Suitable high temperature ultrafiltration membranes 34 for use herein are available from GE Osmonics.

The ultrafiltration membrane 34 can be formed into any suitable configuration such as a flat sheet, hollow fiber and the like. As one skilled in the art will readily appreciate, the flat sheet can be further formed into a configuration such as a spiral wound module or a plate-and-frame. A preferred configuration for use herein is a spiral wound module. The ultrafiltration membrane 34 used herein will ordinarily process from about 2 to about 8 gallons per minute and preferably from about 4 to about 6 gallons per minute of the filtered produced water stream 24. A full scale operation can use multiple ultrafiltration membranes 34. The pressure differential maintained across the ultrafiltration membrane 34 will ordinarily range from about 10 psig to about 40 psig and preferably between about 20 psig to 30 psig.

The ultrafiltration permeate 38 recovered from the low pressure side 36 of the ultrafiltration membrane 34 has a reduced concentration of insoluble organic and inorganic contaminants. The concentration of insoluble inorganic contaminants can be, for example, less than about 100 ppm and preferably less than about 10 ppm. The percentage of the filtered produced water stream 24 recovered as the ultrafiltration permeate 38 will ordinarily range from about 90% to about 100% and preferably about 95%. The ultrafiltration retentate 39 recovered from the high pressure side 32 of the ultrafiltration membrane 34 can be recycled back to the prefiltration tank 26 at the front end of the produced water treatment system 12.

### Nanofiltration

Following the UF stage 30, the ultrafiltration permeate 38 is passed into contact with a high pressure side 42 of nanofiltration membrane 44 in the NF phase 40 to reject hardness, soluble iron and organics. Desirably, the NF phase 40 removes soluble organics of less than 200 molecular weight and inorganic salts like barium, calcium, iron and magnesium. After the removal of these contaminates, the NF permeate 48 is then passed to the subsequent RO phase 50 for removal of silica and boron. The pH of the ultrafiltration permeate 38 passed to the NF phase 40 is maintained between 4.5 and 6.9 to minimize fouling of the NF membrane 44. A pH greater than about 6.0 causes FeS to precipitate on the NF membrane 44. Because the treated water typically will always have iron and some H₂S gas, it is desirable to keep pH less than about 5.5, and desirably about 5.0 pH. This also maximized the sulfate content in the treated water, which in turn maximized the hardness removal (calcium and magnesium). It was found that pH below about 4.5 prevented adequate performance of the antiscalant leading to fouling of the NF membrane 44. At this low pH, the antiscalant does not disassociate, thereby becoming less and less effective.

The NF membrane 44 can be formed into any suitable configuration such as a plate-and-frame form, spiral wound, tubular, capillary and hollow fiber formats, from a range of materials, including cellulose derivatives and synthetic polymers, from inorganic materials, ceramics especially, and from organic/inorganic hybrids. Suitable high temperature NF membranes 44 for use herein are available from GE Osmonics. A preferred configuration for use herein is a spiral wound module. The pressure differential maintained across the NF membrane 44 will ordinarily range from about 150 to about 300 psig and preferably from about 175 to about 225 psig.

The NF permeate 48 recovered from the low pressure side 46 of the NF membrane 44 is reduced in concentration of hardness, soluble iron and organics leaving an NF retentate 49. The percentage of the ultrafiltration permeate 38 recovered as the NF permeate 48 will ordinarily range from about 90 to about 99% and preferably about 95%. The NF retentate 49 recovered from the high pressure side 42 of the NF membrane 44 is desirably disposed of through deep well injection.

### Reverse Osmosis

Subsequently, the NF permeate 48 is treated by a reverse osmosis (RO) system 51 in the RO phase 50. In one embodiment, the RO system 51 is a two-pass system having a first-pass RO system 52 and a second-pass RO system 53. In the first-pass RO system 52, the NF permeate 48 is maintained at its elevated temperature and low pH and the majority of the salts and silica is removed. In one embodiment, the first-pass RO system 52 maintains the NF permeate 48 at a temperature of 180° F. (82° C.) and pH of 5.8 to reduce potential silica scaling on the second-pass RO system 53 while removing some boron. Suitable reverse osmosis membranes for use in the first-pass and second-pass RO systems 52, 53 are available from GE Osmonics.

The first-pass RO permeate 58 from the first-pass RO system 52 is sent to an air stripper system 60. While the air striper system 60 in this embodiment is between the first-pass RO system 52 and the second-pass RO system 53, it may also be located upstream of the first-pass RO system 52. Common types of air stripper systems 60 include packed towers, multi-staged bubble systems, venturi eductors, and spray nozzles. The air stripper system 60 is used to remove carbon dioxide, but may also be used to remove volatile organics, radon, trihalomethanes, methane, and hydrogen sulfide, and may also be used to oxidize iron, for subsequent removal by filtration. In the present system 12, the primary role of the air stripper system 60 is to remove carbon dioxide and to decrease the temperature of the first-pass RO permeate 58 to a temperature of at least 95° F. (35° C.) before the second-pass RO system 53 and discharge of the treated water.

From the air stripper system 60, the pH of the first-pass RO permeate 58 is raised to a pH of desirably at least 10.0 for improved boron removal. The second-pass RO system 53 may be accomplished with a standard brackish RO membrane and system components operating at ambient temperatures for surface discharge. Desirably, the pH is adjusted with NaOH. Using a pH controller 59, liquid NaOH is desirably diluted down to 1-2% solution with RO permeate. Because the permeate is void of hardness and buffers, it typically takes a small amount of NaOH to adjust the pH to the desired level. The NaOH is injected into the feed line to second-pass RO system 53 before prefilters with an in line static mixer to make sure the pH adjustment goes up to maximize boron and silica rejection. However, the addition of NaOH may cause point precipitation of any residual hardness not properly mixed, and the kinetics of returning hardness into solution are much slower than precipitation. This makes CO₂ stripping and chilling a combined process function and dramatically reduces the amount of NaOH needed to raise the pH to at least 10 for maximum borate removal and the reliability of the both RO systems 52, 53.

Additionally, it may be desired to further reduce the level of boron in second-pass RO permeate 68 of the second-pass RO system 53. For example, it was found that the boron rejection at a pH of at least 10 is 99% at 75° F. (24° C.). However, sometimes, due to ambient temperature constraints, cooling the first-pass RO permeate 58 to such a temperature is not practical or cost effective. It was found that boron discharge limits may not be met with the second-pass RO system 53 operating at a temperature of 90° F. (32° C.). In such instances, trace residual boron (5-10 ppm) in the second-pass RO permeate 68 may be removed using selective ion exchange in ion exchange phase 70 using ion exchanger 72. Desirably, the second-pass RO permeate 68 is suitable surface discharge, although it may require some mineral or chemical addition and/or temperature change in order to comply with particular aspects of state and/or federal regulations.

### Example 1

A produced water stream from oil recovery operations containing high concentrations of contaminants was subject to oil separation and passage through a produced water treatment system 12 using a multiple membrane technology approach. The produced water stream had a temperature of 185° F. (85° C.). The produced water stream contained high levels of salts (about 10,000 ppm), oil (<10 PPM), suspended solids, iron at saturation, silica at saturation (about 200 ppm) and boron (100-150 ppm). In the prefiltration phase, 0.125 gallons of 93% H₂SO₄ was added per 1000 gallons of produced water as feed. A 50 micron cartridge filter was used in the prefiltration stage.

The flow rate to the UF phase and the NF phase was 20 GPM. The UF phase used four 8 inch×40 inch (20 cm×102 cm) model MW8040CJL elements. The NF phase used four 8 inch×40 inch (20 cm×102 cm) model DK8040CJO elements. The NF permeate was fed directly to a high temperature Osmonics 80B first-pass RO system and the subsequent second-pass low-pressure brackish water RO system. These RO systems used eight 4 inch×40 inch (10 cm×102 cm) elements. The average operating temperature for the UF phase and the NF phase was 185° F. (85° C.). The first-pass RO system had an average operating temperature of 180° F.

Both the UF and NF systems used VFD on feed pump motors and high volume re-circulation pumps. The UF system used 80 GPM re-circulation and ran at a high recovery of greater than 90%. The permeate flow in the UF system was controlled with permeate backpressure valves, and permeate was removed from both ends of a 4-element 8 inch (20 cm) stainless pressure vessel. This allowed control of the pressure to maintain a permeate flux of about 22-25 GFD. The high temperature resulted in a relatively low net driving pressure (NDP) of about 20 PSI for the UF phase.

The NF membrane featured a once through Christmas tree array with short times of the feed in the system. The membrane flux was 15 GFD with a net driving pressure of 175 to 225 PSI. The pH was maintained between 4.5 and 6.9 to minimize fouling on the NF membrane. It was found that pH below about 4.5 prevented adequate performance of the antiscalant leading to fouling of the NF membrane. A pH greater than about 6 caused FeS to precipitate on the NF membrane. Because the treated water always had iron and some H₂S gas, pH was maintained less than 5.5, and desirably at 5.0 pH. This also maximized the sulfate content in the feed, which in turn maximized the hardness removal (calcium and magnesium).

The 80B RO system was operated at a temperature of between 175° F. and 180° F. The 80B RO system used 8 model SE4040FDA elements. The temperature was kept elevated with the feed to the first-pass RO system at pH 5.8. The elevated temperatures and high quality feed kept the silica in solution despite recoveries of 85%. The first-pass RO system was run to removal residual hardness, most of the chlorides and silica. The first-pass RO ran at high temperature on NF permeate (pH 5.8 and virtually no hardness), seemed to minimize potential silica scaling and removed some boron—both positive outcomes. From a process and economic standpoint, effort was made to keep the first pass RO system pressure less than 600 psi.

The first-pass RO permeate was collected in a 500 gallon tank and chilled. The first-pass RO permeate was air stripped of CO₂ by re-circulating from the feed tank to a second tank and then returning it to the feed tank. The CO₂ stripped water was simultaneously chilled to 95° F. and then pH adjusted to greater than 10 with 50% NaOH. NaOH was added at a rate of 0.237 gallons of 50% NaOH per 1000 gallons of first-pass RO permeate. The second-pass RO system was run at low pressures of 150 psi and high recoveries of 95%. Raising the pH on the second-pass feed made the pH addition both less complicated and less costly. It was found that point precipitation can be a problem, and trace amounts of hardness, CO₂ and reactive silica at saturation in the NF permeate provided nucleation sites that would nearly immediately start to form point precipitation. So, the NF permeate was kept as it was received at low pH and fed directly to first-pass RO system. The first-pass RO system removed all hardness, 75% of the silica and some boron. This gave us a straightforward, reliable and cost effective process for pH adjustment on the second-pass feed.

Because of the high feed boron levels, it was necessary to incorporate the ion exchange phase to insure less than 0.75 ppm boron in the treated water. Table 1 lists rejection of specific ions.

TABLE 1
Rejection of Specific Ions

| | Feed | | 2^{nd} Pass RO Permeate | | |
|---|---|---|---|---|---|
| | (UF Permeate) | | at 95% Recovery | | % Rejection |
| Conductivity | 19510 | μS | 195μ | | 99% |
| Sodium | 4570 | mg/l | 28.6 | mg/l | 99.2% |
| Calcium | 220 | mg/l | 0.24 | mg/l | 99.9% |
| Magnesium | 61 | mg/l | ND | | 100% |
| Potassium | 100 | mg/l | ND | | 100% |
| Ammonium | 110 | mg/l | 5.6 | mg/l | 95.6% |
| Chloride | 6260 | mg/l | 3.72 | mg/l | 99.6% |
| Sulfate | 960 | mg/l | ND | | 100% |
| Silica, reactive | 200 | mg/l | 0.6 | mg/l | 99.7% |
| Boron | 110 | mg/l | 7.5 | mg/l | 93.2% |
| Total Organic | 119 | mg/l | 20 | mg/l | 83.2% |
| Carbon (TOC) | | | | | |

Despite the difficult nature of the produced water, the application of three distinct membrane technologies (UF, NF and double pass RO) proved to be reliable in the quantity and quality of treated water. The total dissolve solids limits for surface water discharge limits <1000 ppm for permeate qualities were far exceeded after the second-pass RO membrane treatment. In fact, the final RO permeate contained about 150 ppm of sodium chloride. An ion-exchange (IX) media then selectively removes remaining trace boron in the RO permeate. The IX process was cost-effective because of the high quality of the RO permeate, and its presence in the process stream safely maintained boron levels below a 0.75-ppm surface discharge limit.

The high temperature membrane technology combined with ion exchange met the surface discharge quality limits for TDS and boron required by federal and state clean water mandates. Furthermore, the multiple membrane technology approach gave one a choice as to how much treatment should be done to meet their various water balance needs. In some cases, UF only was required for direct re-injection of produced waters. Whereas, UF-NF followed by IX softening would be cost effective and provide sufficient treatment for low-pressure boiler feed applications. In other cases, temperature processing of UF-NF and single pass RO would be sufficient for high-pressure steam generation. Finally, if maintaining water balance means that surface discharging some of the membrane treated produced water, then the full treatment approach of UF-NF-double pass RO-IX was used. The process was able to produce water that met surface discharge limits and recovered about 95% of the original feed.

### Example 2

A produced water stream from oil recovery operations containing high concentrations of contaminants was subject to oil separation and passage through a produced water treatment system 12 using a multiple membrane technology approach. A 75 micron cartridge filter was used in the prefiltration stage. The average operating temperature for the UF phase, the NF phase and the RO phase was 165° F. (73° C.). The UF phase had a net driving pressure (NDP) of about 20 PSI and 100% recovery. The UF permeate was saturated in silica at 2780 ppm. The NF phase had a net driving pressure (NDP) of about 200 PSI and greater than 90% recovery. The NF permeate had hardness less than 2 ppm, TDS of 1180 ppm and saturated in silica. A single pass RO system was used operating at 300 PSI and greater than 90% recovery. The treated make-up water had less than 20 ppm TDS, less than 1 ppm silica and less than 0.2 ppm hardness.

### Example 3

A produced water stream from oil recovery operations containing high concentrations of contaminants was subject to oil separation and passage through a produced water treatment system 12 using a multiple membrane technology approach. The prefiltration stage used a free oil knock-out tank, induced gas floatation, a walnut shell filter and a 25 micron cartridge filter. The average operating temperature for the UF phase, the NF phase and the RO phase was 165° F. (73° C.). The UF phase had a net driving pressure (NDP) of about 30 PSI. The UF permeate was saturated in silica at 2780 ppm. The NF phase had a net driving pressure (NDP) of about 160 PSI and greater than 90% recovery. The NF permeate had hardness less than 2 ppm, TDS of 484 ppm, and silica of 212 ppm. A single pass RO system was used operating at 300 PSI and greater than 92% recovery. The treated make-up water had less than 25 ppm TDS, less than 3 ppm silica and less than 0.2 ppm hardness.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A process for treating a produced water stream from oil recovery operations having a temperature between 160° F. (71° C.) and 200° F. (93° C.) and containing high concentrations of soluble and insoluble organic and inorganic contaminants, the process comprising:
passing the produced water stream to a pretreatment phase to obtain a filtered produced water stream;
passing the filtered produced water stream to an ultrafiltration (UF) phase to recover an ultrafiltration permeate;
passing the ultrafiltration permeate to a nanofiltration (NF) phase to recover a nanofiltration permeate; and
passing the produced water stream to a reverse osmosis (RO) phase to recover a reverse osmosis permeate having a reduced concentration of salts, silica and boron.

2. The process of claim 1 wherein the RO phase comprises a two-pass system having a first-pass RO system to remove salts and silica and a second-pass RO system to remove boron.

3. The process of claim 2 further comprising subjecting a first-pass RO permeate to an air stripper system and to a pH adjustment, wherein the pH of the pH adjusted first-pass RO permeate is.

4. The process of claim 3 further comprising adjusting the pH of the first-pass RO permeate from the air stripper system, wherein the pH is raised from an initial pH between 4.5 and 6.0 to a pH of at least 10 for improved boron removal.

5. The process of claim 4 further comprising further comprising passing a second-pass RO permeate to an ion exchanger.

6. The process of claim 1 wherein the ultrafiltration permeate recovered from a low pressure side of an ultrafiltration membrane has reduced oil and suspended solids.

7. The process of claim 1 wherein the nanofiltration permeate recovered from a low pressure side of a nanofiltration membrane has a reduced concentration soluble organics of less than 200 molecular weight, hardness and iron.

8. The process of claim 1 further comprising subjecting the produced water stream to a pH adjustment, wherein the pH of the pH adjusted produced water stream is less than 6.0.

9. A process for treating a produced water stream from oil recovery operations having a temperature between 160° F. (71° C.) and 200° F. (93° C.) and containing high concentrations of soluble and insoluble organic and inorganic contaminants, the process comprising:
passing the produced water stream to a pretreatment phase to obtain a filtered produced water stream, wherein the produced water stream is subjected to a pH adjustment, wherein the pH of the pH adjusted produced water stream is less than 6.0;
passing the filtered produced water stream to an ultrafiltration (UF) phase to recover an ultrafiltration permeate having reduced oil and suspended solids;
passing the ultrafiltration permeate to a nanofiltration (NF) phase to recover a nanofiltration permeate having reduced soluble organics, hardness and iron;
passing the nanofiltration permeate having a pH between 4.5 and 6.0 to a two-pass reverse osmosis (RO) phase to recover a reverse osmosis permeate, the RO phase comprising a first-pass RO membrane that rejects salts and silica and a second-pass RO membrane that rejects boron, wherein a first-pass RO permeate is subjected to an air stripper system that removes CO₂ and cools the first-pass RO permeate to less than 95° F. (35° C.), and said first-pass RO permeate is subjected to a pH adjustment, wherein the pH is raised to at least 10 for improved boron removal.

10. The process of claim 9 further comprising passing a second-pass RO permeate to an ion exchanger.
